(19) United States
(12) Patent Application Publication
(10) Pub. No.: US 2012/0078775 A1
(43) Pub. Date: Mar. 29, 2012

(54) Electronic call auction trading system and method

(75) Inventor: Kevin Callahan, Norwalk, CT (US)

(73) Assignee: Axe ATS, LLC

(21) Appl. No.: 13/246,526

(22) Filed: Sep. 27, 2011

Related U.S. Application Data
(60) Provisional application No. 61/404,095, filed on Sep. 27, 2010.

(51) Int. Cl. G06Q 40/04

(52) U.S. Cl. 705/37

(57) ABSTRACT

A computer-implemented method for initiating a call action trade including the steps of providing at least one user trade request to a computer system and sending out third party trade invitations from the computer system contingent upon the user trade request seeking to find liquidity for the trade request. It further includes the facilitating in the computer system an electronic trade auction between a third party having liquidity and the user for the user trade request.

### FIELD OF THE INVENTION

The invention relates to an electronic call auction system and method, and more specifically to an electronic call auction system and method for accessing liquidity in securities trading.

### BACKGROUND OF THE INVENTION

A recognized problem for “thinly-traded securities” is a large buyer of a thinly-traded stock can quickly drive the price up 5%, 10% or even more. The same is true for a large seller who can send the price spiraling downward. This problem is generally referred to as “market impact,” the idea that your order has a negative impact on the market price. While market impact is not a major issue for the top 20% of stocks that trade frequently, it is a major problem for the bottom 80% of stocks that are more thinly-traded. For instance, more than half of all stocks trade less than 100,000 shares a day.

There is a bit of a “prisoner's dilemma” that occurs in the trading of more thinly-traded securities. A large potential buyer, for instance, does not want to go to the market for fear of driving the price upward. Meanwhile, a large seller does not want to go to the market for fear of driving the price downward. Therefore, buyer and seller never meet and a trade never takes place.

The root cause of the problem lies in the mechanism that dominates modern stock trading, which is referred to as a “continuous, order-driven” market. Basically, this means that buyers and sellers submit limit orders to the market and these orders are posted or displayed, generally to all market participants. The best priced buy order or “bid” (e.g. the highest price someone is willing to buy) and the best priced sell order or “offer” (e.g. the lowest price someone is willing to sell) represent the “top” of the market and the difference between the two represents the market “spread.” Market orders that are sent to the market will be executed against the best bid or offer. For instance, a market order to buy is executed against the best priced sell order.

The continuous, order-driven market works well enough for more heavily-traded stocks because there is always an adequate supply of bids and offers and the market can adequately “absorb” even a larger size order. However, this market mechanism is not effective when trading more thinly traded stocks. For example, even a 1,000 share order in a stock such as Edgwater Technology (EDGW) that trades around 10,000 shares per day, can rapidly drive the price substantially higher or lower.

It is to be appreciated there are three known ways to mitigate the problem of the continuous, order-driven market: namely, algorithms, “dark pools” and third-market brokers, each discussed below.

Algorithms are automated trading strategies that are implemented by computer programs controlling the pricing and timing of order submittals to the market. Generally, an algorithm takes a larger order and breaks it down into multiple, smaller orders and then submits these orders to the market in a way that disguises the buyer or seller's ultimate objectives. Algorithms can be configured to be more “aggressive” (e.g. hitting bids and offers, sopping up all available liquidity) or more “passive” (e.g. not displaying bids or offers, only submitting “dark” orders, etc.)

However algorithms don't really address the underlying problems of the continuous, order-driven market; they simply try to best adapt to its shortcomings. For this reason, algorithms are generally thought to be effective for more heavily-traded stocks, but are not all that helpful for more thinly-traded stocks. Take the example of EDGW above. Using an algorithm to buy 100,000 shares could take weeks to implement and could easily be reverse-engineered by savvy market participants to the investor's disadvantage.

Another known solution is Dark pools, which are non-displayed order matching venues. Unlike the continuous, order-driven market which displays limit orders to all market participants, dark pools do not (or should not) display their limit orders. If your limit order to buy matches up with a corresponding limit order to sell, then your orders will be matched or crossed in the dark pool, typically at the midpoint of the bid-ask spread.

Dark pools, however, hardly address the problem of finding liquidity in more thinly-traded securities. Dark pools require that both buyers and sellers are present in the market at exactly the same time at or near the same price. This is a higher likelihood for more heavily-traded stocks but becomes a near impossibility for thinly-traded stocks. Also, buyers and sellers are very reluctant to allow orders to “rest” in a dark pool because their orders can be “pinged” (the process of sending a series of small orders to sniff out if a larger order exists in a dark pool).

The other known solution to the problems of the continuous, order-driven market is so-called “Third Market” or “Upstairs” brokers. A large buyer of a more thinly-traded stock can call a third-market broker who will then reach out to other institutional “holders” of the stock (which is generally public information) to see if there are any willing sellers and will then try to conduct an off-market, block trade.

It is thus to be appreciated that if the problem of Dark Pools is that they do not share enough information to attract liquidity to a thinly-traded stock (after all, they are “dark”), the problem of third-market brokers or upstairs trading is that they share too much information. Institutional investors know that as soon as they pick up the phone and call a broker, they have lost control over how—and to whom—their trading intentions will be conveyed. Despite their best intentions, third-market brokers often give too much information to the wrong counterparties, which has negative consequences on the investor seeking liquidity.

Accordingly a need exists for a system operable to trade thinly-traded securities which only selectively discloses trade information to seek liquidity but does not compromise the trader's positions leading to higher trading costs.

### SUMMARY OF THE INVENTION

An aspect of the invention relates to a computer-implemented method for initiating a call action trade including the steps of providing at least one user trade request to a computer system and sending out third party trade invitations from the computer system contingent upon the user trade request seeking to find liquidity for the trade request. It further includes facilitating in the computer system an electronic trade auction between a third party having liquidity and the user for the user trade request.

Another aspect of the invention includes wherein the step of providing the at least one user trade request includes providing information relating to trade details to be displayed by the computer system to the third and wherein the step of providing the at least one user trade request includes providing distribution information to be used by the computer system for sending out the third party trade invitations. Yet another aspect of the invention includes wherein the step of facilitating in the computer system an electronic trade auction includes the step of the computer system acquiring a current market price for assets included in the electronic call trade auction and the step of facilitating in the computer system an electronic trade auction includes the step of the computer system pricing the assets of the electronic call auction. A still further aspect of the invention includes wherein the step of facilitating in the computer system an electronic trade auction includes the step of the computer system allocating assets of the electronic call auction between the user and at least one third party and the of facilitating in the computer system an electronic trade auction includes the step of the computer system determining if the auction price of the assets of the electronic call auction satisfy a predetermined price and/or allocation threshold.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is a system level diagram of the present invention system depicting an environment of use and implementation according to an illustrated embodiment;

FIG. 2 is a system level diagram of the present invention system for conducting electronic call auctions according to an illustrated embodiment; and

FIG. 3 is a flow chart depicting the a method of use and operation of the system of FIG. 2.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

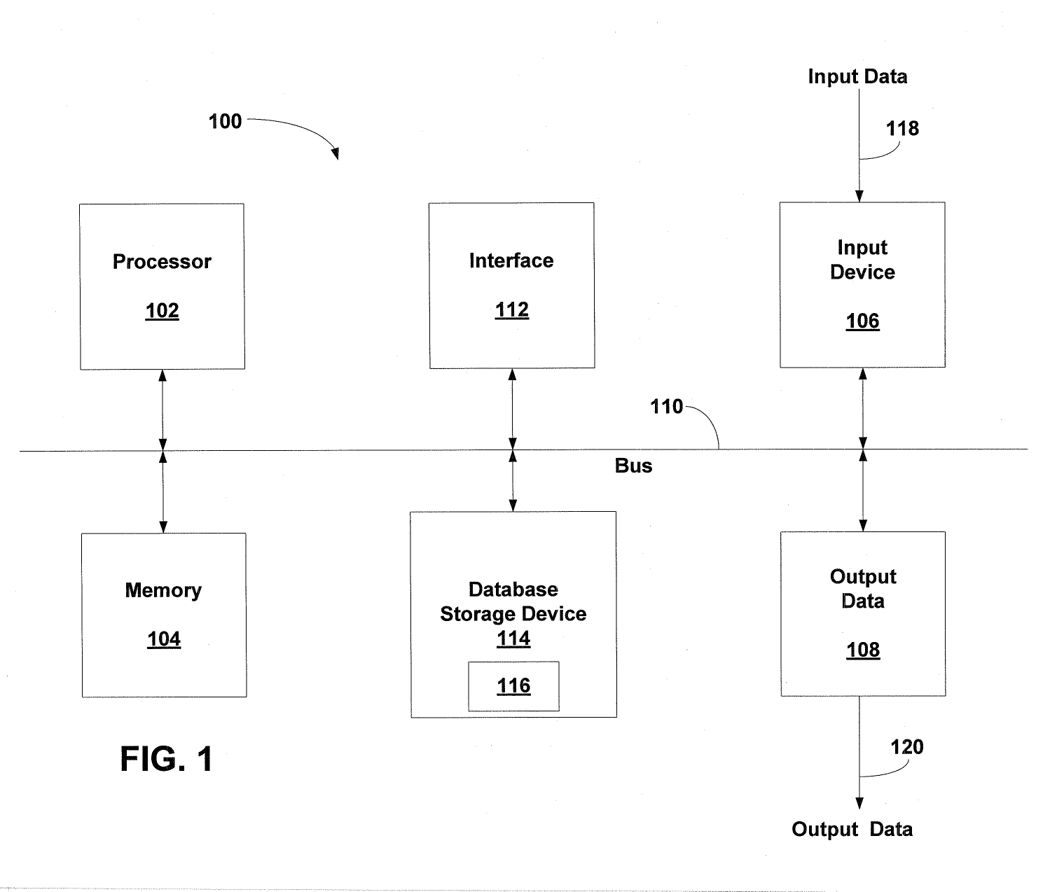

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1 being generally shown and discussed above, the present invention system and method in accordance with the illustrated embodiments will now described

It is to be understood the present invention system and method provides a safe and effective way for investors to find liquidity in more thinly-traded stocks. One aspect of the invention is the present invention system and method utilize a call auction model as opposed to a conventional predominant bid-offer, continuous, order-driven market model. In such a call auction, buyers and sellers submit limit orders and these limit orders are aggregated together and “matched” at a common clearing price. The price is typically set at the price that maximizes the amount of shares traded in the cross (e.g. the highest number of buyers and sellers).

It is to be understood there are two principal ways in which a call auction is different from the continuous, order-driven model. First, a call auction occurs at a point in time rather than running continuously. All orders are submitted prior to the call and then brought together when the market is called. In the traditional market, bids and offers can be hit at any time by anyone who submits an order to hit the bid or take the offer. Second, a call auction allows for a multi-lateral trade at a single clearing price rather than just a bi-lateral trade that occurs at either the buyer or seller's limit price. The traditional order-driven model only matches one buyer with one seller. In heavily traded stocks, thousands of these transactions can take place in a second but each transaction is a bi-lateral trade. The call auction allows for a multi-lateral trade between potentially multiple buyers and sellers.

It is to be appreciated that using call auctions to trade stocks is known. A noted advantage of using a call auction for trading thinly-traded securities relates to the differences between a call market and a traditional order-driven market: Aggregation of orders at a point in time; and conducting multilateral trades at a single clearing price. Aggregation of orders is important for trading thin stocks because there typically are not enough buyers and sellers to support a continuous market. In a heavily traded stock such as Apple Computer (APPL), there are hundreds if not thousands of active buyers and sellers in the market at the same time. In a thinly-traded stock, this number is often reduced to the point where perhaps only a few, if any, buyers and sellers are actively looking to trade at exactly the same time. This is known in the art as “trade by appointment,” meaning that an investor or broker needed to schedule a time with the specialist to trade the stock. During those discrete periods, the specialist would try to bring as many buyers and sellers together to trade the stock. However, in view of today's electronic systems (e.g., the specialist role has disappeared), this activity has moved “upstairs” to the third-market brokers who try to aggregate buyers and sellers at a point in time to trade a block of stock. Thinly-trade stocks tend to trade very episodically, large trades occurring at discrete times and then otherwise experiencing very low trading activity.

Another noted advantage of a call auction is that it typically conducts a multilateral trade at a single clearing price. This is especially important for thinly-traded stocks because investors often do not have confidence in the “market” prices for these stocks. Take the example of EDGW, whose “last sale” prices will typically fluctuate between the bid and ask, often a difference of up to 5%. Also, “last sale” is typically only for 100 shares. But what is the right price to buy or sell 100,000 shares? A call auction typically provides superior “price discovery” for these type of stocks because it reflects the market sentiment of potentially multiple buyers and sellers. Also, in a call auction, a participant is more likely to submit a more aggressively-priced limit order because: a) this limit order will typically not be displayed to anyone else; and b) the call auction will not necessarily occur at their limit price (although it could). Thus, it is to be appreciated a call auction encourages all buyers and sellers to use their best efforts, which ultimately results in a better price discovery.

However, a noted downside of a traditional call auction is that it does not afford any immediacy to the trade. Traditionally, a participant would have to wait for the next call and the timing of the call may not coincide with the participant's investment objectives. Typically, the exchange operator would schedule the timing of the call auction.

In the system and method according to the present invention, as to be further described below, a “user-initiated” call auction model is disclosed. “User-initiated” is to be understood that any large buyer or seller of a stock can call their own auction at any time. For instance, it is somewhat analogous to Sotheby's versus eBay model. In the Sotheby's model, the auctioneer schedules the timing of the auction (“Next Tuesday, we will have a 18^{th} century American Antiques Auction”). However, in the eBay model, anyone with something to sell can start their own auction at any time. The present invention is to be understood to be more akin to the eBay model.

A noted advantage of a user-initiated call auction is that it lends a sense of immediacy to the trade. Therefore, in the present invention system, all the benefits of a call auction are maintained while also addressing a primary disadvantage of a call auction (e.g., lack of immediacy).

Another noted advantage of the present invention is that the “initiator” of the auction has the ability to broadcast targeted messages (known hereinafter as Invitations to Trade (ITTs)) to selected market participants, alerting them that an auction is going to take place. The initiator has the ability to determine what information they want to show about the auction (e.g., “display” options) and also to whom they want to show that information (e.g., “distribution” options).

Thus, in accordance with the present invention, one party can actually choose to show certain information about their trade to certain counterparties which is counter intuitive to the long-held view that securities trading should be “anonymous.” It is noted brokers and regulators have long advocated that trading should be completely anonymous; buyers and sellers should have no knowledge of one another. This view, of course, is a bit self-serving on the part of the broker as traditionally the best way to preserve anonymity was to use a broker as the middleman who conceals the identity of the end buyer or seller.

It is to be appreciated that anonymity is only one variable that an investor can adjust when deciding how they want to achieve best execution. Anonymity is a component of the present invention, as discussed further below. It will be understood the present invention system enables an investor to control what level of anonymity they want to have on any one trade. On the one hand, the more information they share on themselves and the trade they are trying to execute, the more liquidity they are likely to attract. On the other hand, the more information they give about themselves and the trade, the higher likelihood that someone could take advantage of the information. The present invention system enables the investor to make these tradeoffs between liquidity on the one hand and complete anonymity on the other hand.

It is to be appreciated that the present invention system eliminates the principal-agent problem because the principal gets to decide what information is shared and with whom. It is to be understood the present invention provides a novel trading system that allows this information to be shared electronically directly between investors.

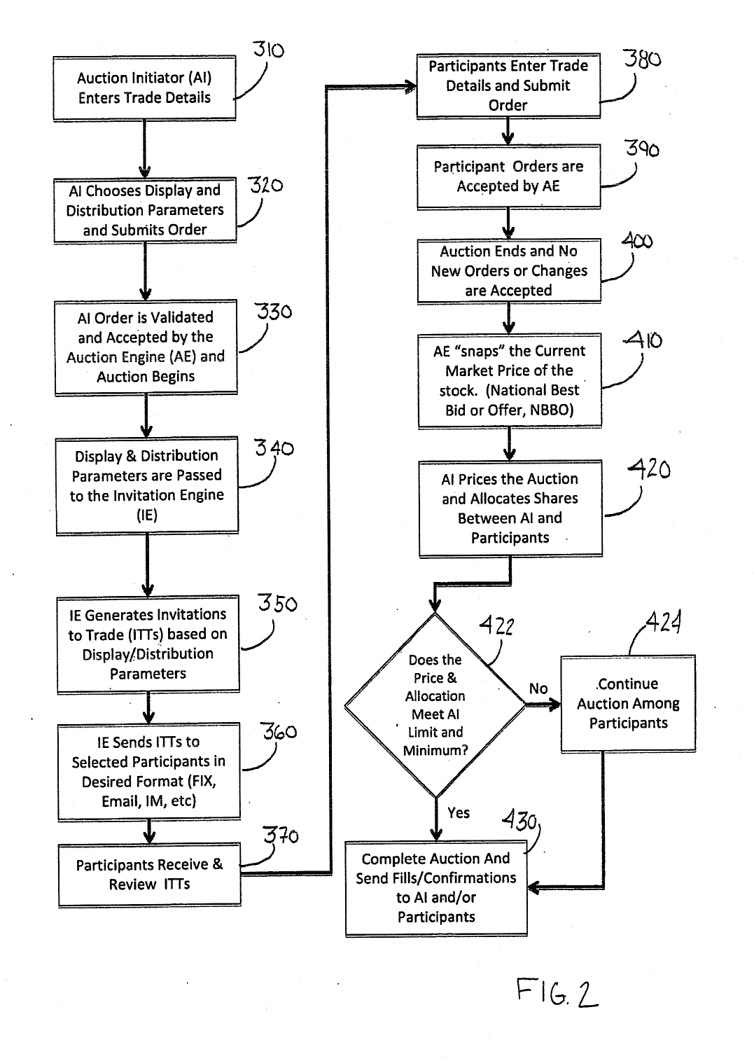

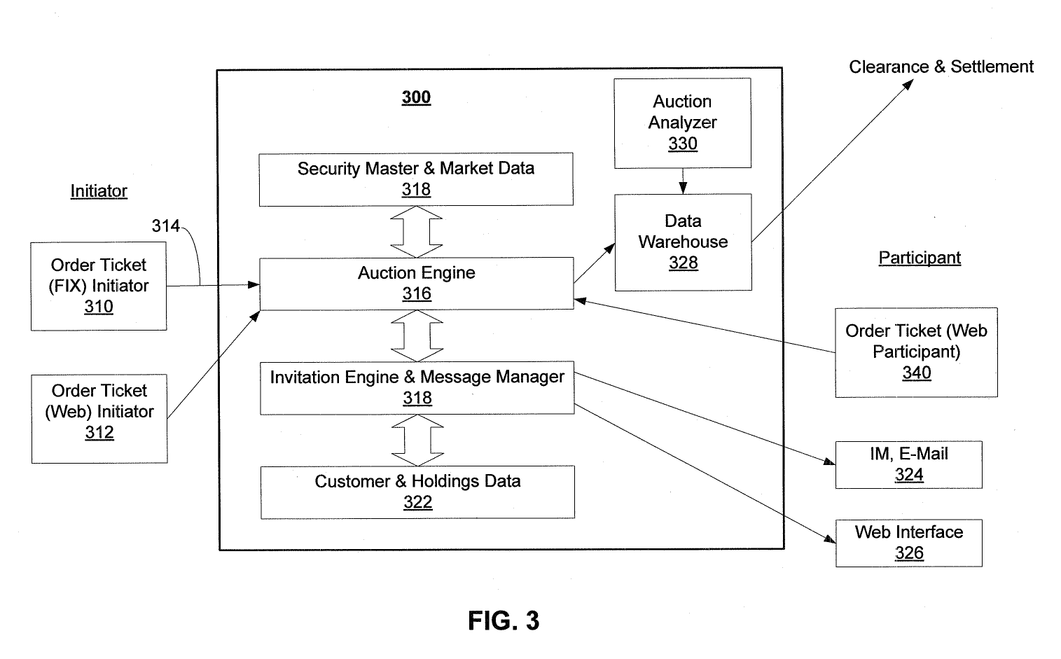

With concurrent reference now to FIGS. 2 and 3, the system and method of the present invention in accordance with the illustrated embodiments will now be generally described. As shown, trade orders can be submitted into the present invention trading system (indicated as the Trading System 300 in the exemplary embodiment of FIG. 3) preferably through two methods. The first being via FIX format preferably from a customer's Order Management System (OMS) 310 or an Execution Management System (EMS). The second being from an Internet-based order entry system 312.

With regards to using the aforesaid FIX format, the present invention system includes a standard FIX specification configured and operable to be provided to OMS/EMS vendors for incorporating the present invention “order ticket” submission module into their respective systems. Therefore, these orders will be sent to the Trading System 300 via a certified FIX connection 314.

It is to be appreciated the present invention also includes an Internet-based order entry system configured and operable such that initiators may submit orders to start an auction or participants may submit orders to participate in the auction (step 310).

With continuing reference to FIGS. 2 and 3, and with reference to the Auction Engine 316, all orders are preferably transmitted via FIX or via the Internet to the Auction Engine 316. Once an Initiated order is sent in and accepted by the Auction Engine 316, the present invention then validates the order and starts the auction process (step 330). Preferably, the Auction Engine 316 accesses a Security Master 318 to ensure a valid stock symbol is present for the order. Preferably the present invention also accesses market data and validates that the order is priced within a certain percentage of the market price in order to prevent erroneously-priced orders.

It is to be understood the Auction Engine 316 in accordance with the present invention also accepts any cancel/replace orders during the auction. At the end of the auction, the Auction Engine 316 preferably prices the auction and performs all allocations. It also preferably sends back all required confirmations related to all trades that took place in the auction.

It is to be appreciated that an advantage of the present invention trading system is that auction initiators may send an Invitation to Trade (ITT) to other system subscribers, alerting them that an auction is underway and inviting them to participate in the auction, via Invitation Engine 320.

It is to be understood auction initiators can choose certain “Display Options” and “Distribution Options” on an Order Ticket prescribing the information to be displayed regarding the auction and to a prescribed distribution list to which that information is to be displayed to (step 320). These Display and Distribution Options are preferably captured in the Order Ticket (step 310) and sent in via FIX or via the Internet to the Auction Engine 316. The Auction Engine 316 then parses these instructions and sends them to the Invitation Engine (step 340). The Invitation Engine 320 then creates the auction Invitation message such that it is consistent with the “Display” instructions selected by the initiator (step 350). Next, the Invitation Engine 320 preferably develops a list of Invitation recipients consistent with the initiator's “Distribution” instructions. The Invitation Engine 320 preferably accesses a database 322 of customer profiles and stock holdings—information preferably accessed from an outside data provider.

Next, once the message is created and the list of recipients generated, the Invitation Engine delivers the message 324 preferably in a format preferred by the recipient (step 360). For example, the format can include, but is not to be understood to be limited to, the following formats: FIX (via the EMS/OMS system if it can display customer FIX messages); IOI Networks (such as Bloomberg and Autex); Instant Messaging (IM); Email; Web-based Pop Up (the “Message Manager”); and the like.

In accordance with the illustrated embodiments of the present invention, in order to capture the messaging preferences of subscribers and perform other, message-related activities, the present invention may preferably include a web-based interface 326, as indicated by the “Message Manager” as shown in FIG. 3. The Message Manager component preferably allows a subscriber to establish certain message “filters” so that they only view auction-related messages that are most relevant to them. Via the Message Manager component, they can also do things like build a Watch List and view a “Dashboard” of completed trades on the system.

Orders and trade related information is outputted in real-time from the Auction Engine 316 to the Data Warehouse 328. This is preferably accomplished to facilitate activities in customer service, compliance and post-trade processing.

It is to be appreciated the present invention includes a web-based analytics tool, as indicted by the Auction Analyzer 330 in FIG. 3. The Auction Analyzer 330 component preferably enables system operators to view all orders—in both real-time and post-trade—that are sent in to initiate and participate in an auction. This enables system operators to monitor all activity on the Trading System 300, which can be used for customer service and compliance purposes.

With returning reference to FIG. 3, once the Invitation Engine 300 delivers the message of step 360, participants receive and review the Invitations to Trade (step 370). If desired by a participant, the participant may submit to the Trading System 300 an order 340 having the requisite trade details (step 380), which participant orders are then accepted by the Auction Engine 300 (step 390). Once an auction ends, no new participant orders and/or changes to participant orders are accepted by the Auction Engine 300 (step 400) The Auction Engine 300 then preferably acquires the current market price of the subject asset (step 410) and thereafter prices the auction and allocates shares between the Auction Initiator and the auction participants (step 420). Next, the present invention system preferably determines if the price and allocation of step 420 satisfies the Auction Initiator's threshold price limit and allocation minimum (step 422). If no, then the auction is continued amongst the participants (step 424). And if yes, then the auction is concluded and the system preferably transmits the appropriate information to the participants and/or the Auction Initiator (step 430).

In yet another alternative embodiment of the present invention, the present invention system is configured and operable to automatically perform these functions based on trading intelligence that resides in the system. For instance, rather than the Auction Initiator deciding what information to share and with whom, the system would make these determinations. Thus, rather than having the aforesaid “Display Options” and “Distribution Options,” the system has the functionality to best determine how and where to find this liquidity. The system is thus configured and operable to “learn”—in other words it analyzes past trading and auction precedent to make “automated” decisions.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1. A computer-implemented method for initiating a call action trade comprising the steps of:
providing at least one user trade request to a computer system;
sending out third party trade invitations from the computer system contingent upon the user trade request seeking to find liquidity for the trade request; and
facilitating in the computer system an electronic trade auction between a third party having liquidity and the user for the user trade request.

2. The computer-implemented method for initiating a call action trade as recited in claim 1 wherein the trade request is a share buy request.

3. The computer-implemented method for initiating a call action trade as recited in claim 1 wherein the trade request is a share sell request.

4. The computer-implemented method for initiating a call action trade as recited in claim 1 wherein the step of providing the at least one user trade request includes providing information relating to trade details to be displayed by the computer system to the third parties.

5. The computer-implemented method for initiating a call action trade as recited in claim 1 wherein the step of providing the at least one user trade request includes providing distribution information to be used by the computer system for sending out the third party trade invitations.

6. The computer-implemented method for initiating a call action trade as recited in claim 1 wherein the step of facilitating in the computer system an electronic trade auction includes the step of the computer system acquiring a current market price for assets included in the electronic call trade auction.

7. The computer-implemented method for initiating a call action trade as recited in claim 1 wherein the step of facilitating in the computer system an electronic trade auction includes the step of the computer system pricing the assets of the electronic call auction.

8. The computer-implemented method for initiating a call action trade as recited in claim 1 wherein the step of facilitating in the computer system an electronic trade auction includes the step of the computer system allocating assets of the electronic call auction between the user and at least one third party.

9. The computer-implemented method for initiating a call action trade as recited in claim 1 wherein the step of facilitating in the computer system an electronic trade auction includes the step of the computer system determining if the auction price of the assets of the electronic call auction satisfy a predetermined price and/or allocation threshold.

10. A computer program product comprising a computer useable medium having control logic stored therein for initiating a call action trade, said control logic comprising:
first computer readable program code means for causing the computer to receive and analyze at least one user trade request;
second computer readable program code means for causing the computer to generate and transmit third party trade invitations from the computer contingent upon the user trade request for finding liquidity dependent upon the trade details; and
third computer readable program code means for causing the computer to conduct an electronic trade auction between a third party having liquidity and the user regarding the user trade request based upon transmitted third party trade invitations.

11. A computer program product as recited in claim 10 wherein the first computer readable program code means is programmed to utilize distribution information provided by a user.

12. A computer program product as recited in claim 10 wherein the first computer readable program code means is programmed to utilize user prescribed information relating to trade details to be displayed by the computer system to the third parties.

13. A computer program product as recited in claim 10 wherein the third computer readable program code means is programmed to acquire a current market price for assets included in the electronic call trade auction.

14. A computer program product as recited in claim 10 wherein the third computer readable program code means is programmed to allocate assets of the electronic call auction between the user and at least one third party.

15. A computer program product as recited in claim 10 wherein the third computer readable program code means is programmed to determine if the auction price of the assets of the electronic call auction satisfy a predetermined price and/or allocation threshold.
